(19) United States
(12) Patent Application Publication
(10) Pub. No.: US 2025/0241463 A1
(43) Pub. Date: Jul. 31, 2025

(54) PORTABLE EVENT DISPLAY SYSTEM, METHOD, AND ASSEMBLY KITS

(71) Applicants: Matthew WITTEK, Guelph (CA); Michael David HILL, Huntington Beach, CA (US); John David SHERMAN, Guelph (CA)

(72) Inventors: Matthew WITTEK, Guelph (CA); Michael David HILL, Huntington Beach, CA (US); John David SHERMAN, Guelph (CA)

(21) Appl. No.: 18/910,365

(22) Filed: Oct. 9, 2024

Related U.S. Application Data
(60) Provisional application No. 63/543,277, filed on Oct. 9, 2023.

(51) Int. Cl. A47F 5/11; A47F 5/10; G09F 1/10

(52) U.S. Cl. CPC A47F 5/11; A47F 5/101; G09F 1/10

(57) ABSTRACT

The present disclosure relates to a portable display system, products which can be easily carried to display booth, quickly hand assembled and disassembled without tools, and repackaged for easy transportation on the return trip. In an embodiment, the system includes one or more of a signage stand, shelving, a podium, or even a wall. Each of these items are light weight and conveniently packaged in flat carry containers, and come with parts and pieces and assembly instructions for easily assembling and disassembling the items step-by-step. In another embodiment, the system includes flat parts and pieces that can be assembled together. Each part or piece includes at least one extending tab or slot which is configured to mate with one or more corresponding slots or extending tabs in another part or piece, such that the parts or pieces, when fully assembled form a finished article, such as a signage stand, shelving, a podium, or a wall.

### CROSS-REFERENCE TO RELATED APPLICATIONS

This application claims the benefit of U.S. Provisional Application No. 63/543,277, entitled PORTABLE EVENT DISPLAY SYSTEM, METHOD, AND ASSEMBLY KITS, and filed on Oct. 9, 2023, the entirety of which is incorporated herein by reference.

### FIELD

The present disclosure relates to event display systems, methods, and products.

### BACKGROUND

Conventional signage and shelving play a crucial role in convention display booths. These elements are instrumental in attracting attendees, conveying essential information, and showcasing products or services. Signage serves as the visual identity of a booth, helping attendees identify and remember it amidst a sea of exhibits. These may include banner stands and backdrops, but existing banner stands can be expensive, and heavy to carry.

Shelving systems are also often used, for example to organize and display products or promotional materials while maximizing space efficiency. However, once again, shelving systems for display booths can be heavy, and very time consuming to set up.

At various convention centers, the cost to stage a booth may be determined by the total weight of the signage and furniture required for the booth, and if tools are required to assemble them, then an attendee may be required to hire a convention center employee to perform the assembly and disassembly. The total cost of transporting, staging, assembly, disassembly, and repacking to take away can be quite considerable.

What is needed is an improved portable display booth system which addresses at least some of these limitations in the prior art.

### SUMMARY

The present disclosure relates to a portable display system, method, and assembly kits which can be easily carried to a display booth, quickly hand assembled and disassembled without tools, and repackaged for easy transportation on the return trip.

While ideal for use in a display booth due to the portability and ease of assembly and disassembly, it will be appreciated that the portable display system can also be used for signage or messaging boards at indoor or outdoor events, and for business uses more generally.

In an embodiment, the system includes one or more of a signage stand, shelving, a podium, or a wall, each provided as an assembly kit. Each of these items are light weight and conveniently packaged in flat carry containers, and come with parts and pieces and assembly instructions for easily assembling and disassembling the items step-by-step.

In an embodiment, the system includes flat parts and pieces that can be assembled together. Each part or piece includes at least one extending tab or slot which is configured to mate with one or more corresponding slots or extending tabs in another part or piece, such that the parts or pieces, when fully assembled form a finished article, such as a signage stand, shelving, a podium, or a wall.

In an embodiment, the flat parts and pieces are made from a strong but light weight material, such as a ¼-inch honeycomb board, or light weight plywood.

In a preferred embodiment, the flat parts and pieces are made from materials which are 100% recyclable, such that when they reach end of life, they can be recycled for reuse, rather than going to a landfill.

Advantageously, the present portable display system is convenient, lightweight, easy to assemble or disassemble without tools, and saves cost by allowing a person attending a conference to easily carry everything needed without assistance from a convention center.

### BRIEF DESCRIPTION OF THE DRAWINGS

The present invention, and the objects of the invention will become apparent when consideration is given to the following detailed description thereof. Such description makes reference to the annexed drawings, wherein:

FIG. 1A shows a plan view of a plurality of parts and pieces which can be assembled together to form a podium, in accordance with an illustrative embodiment.

FIGS. 1B-1E show isometric views of the parts and pieces being assembled, step-by-step, to form a finished podium, as shown in FIG. 1F.

FIG. 2A shows a plan view of a plurality of parts and pieces which can be assembled together to form a shelf, in accordance with an illustrative embodiment.

FIGS. 2B-2G show isometric views of the parts and pieces being assembled, step-by-step, to form a finished shelf, as shown in FIG. 2G.

FIG. 3A shows a plan view of a plurality of parts and pieces which can be assembled together to form a stand, in accordance with an illustrative embodiment.

FIGS. 3B-3E show isometric views of the parts and pieces being assembled, step-by-step, to form a finished stand, as shown in FIG. 3F.

FIG. 4A shows a plan view of a plurality of parts and pieces which can be assembled together to form a wall, in accordance with an illustrative embodiment.

FIGS. 4B-4E show isometric views of the parts and pieces being assembled, step-by-step, to form a finished wall, as shown in FIG. 4F.

FIG. 5A shows a plan view of a plurality of parts and pieces which can be assembled together to form another shelf, in accordance with an illustrative embodiment.

FIGS. 5B-5E show isometric views of the parts and pieces being assembled, step-by-step, to form a finished shelf, as shown in FIG. 5F.

FIG. 6A shows a plan view of a plurality of parts and pieces which can be assembled together to form a table, in accordance with an illustrative embodiment.

FIGS. 6B-6D show isometric views of the parts and pieces being assembled, step-by-step, to form a finished table, as shown in FIG. 6E.

### DETAILED DESCRIPTION

As noted above, the present disclosure relates to portable display booth systems, methods, and assembly kits which can be easily carried to a display booth, quickly hand assembled and disassembled without tools, and repackaged for easy transportation on the return trip.

In an embodiment, the system includes one or more of a signage stand, shelving, a podium, or even a wall. Each of these items are light weight and conveniently packaged as an assembly kit in flat carry containers, and come with parts and pieces and assembly instructions for easily assembling and disassembling the items, step-by-step.

In another embodiment, the system includes flat parts and pieces that can be hand assembled without tools. Each part or piece includes at least one extending tab or slot which is configured to mate with one or more corresponding slots or extending tabs in another part or piece, such that the parts or pieces, when fully assembled form a finished article, such as a signage stand, shelving, a podium, or a wall.

Advantageously, the present portable display system is convenient, lightweight, easy to assemble or disassemble without tools, and saves cost by allowing a person attending a conference to easily carry everything needed without assistance from a convention center.

Various illustrative embodiments will now be shown and described.

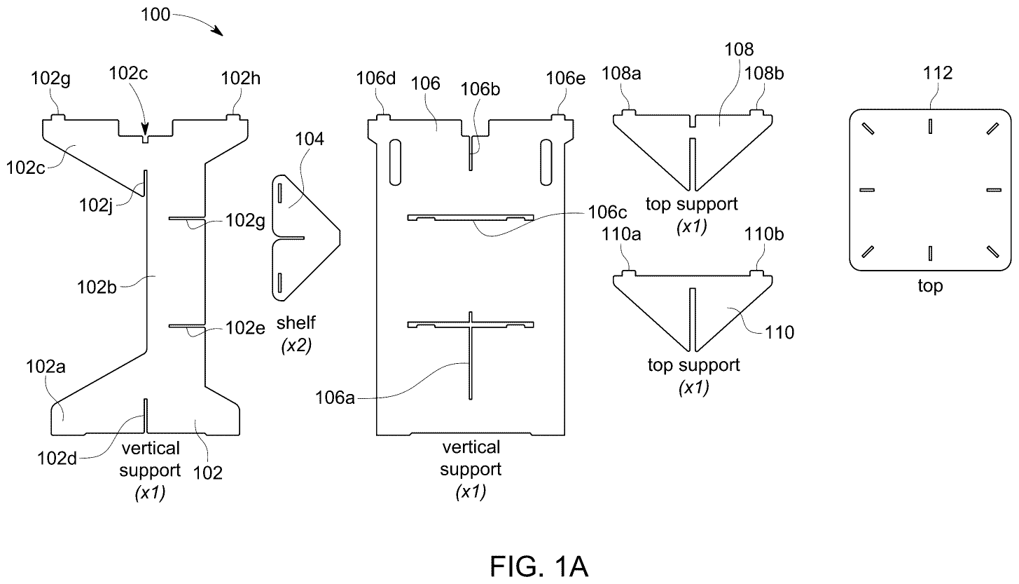

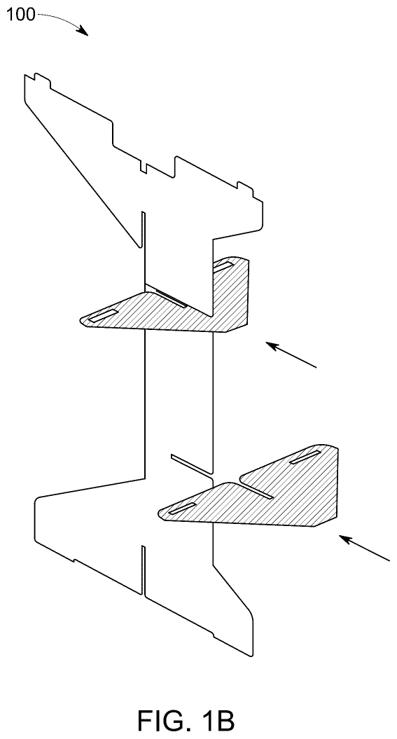

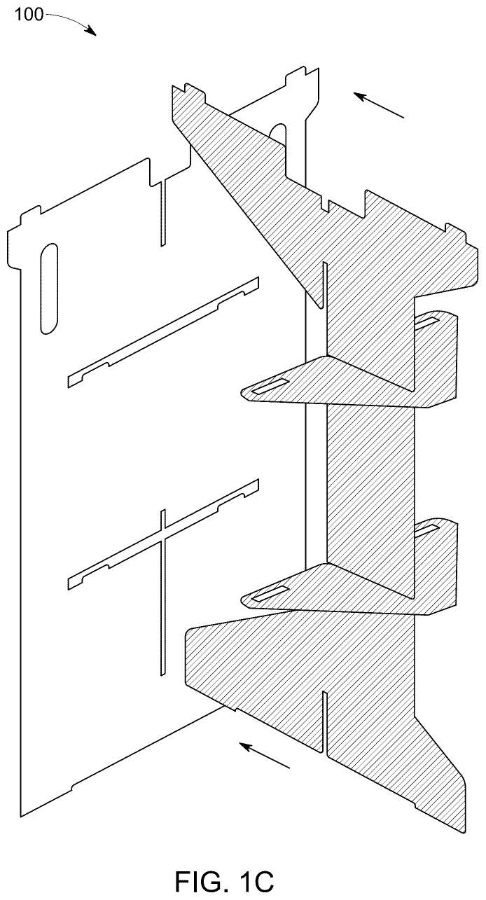

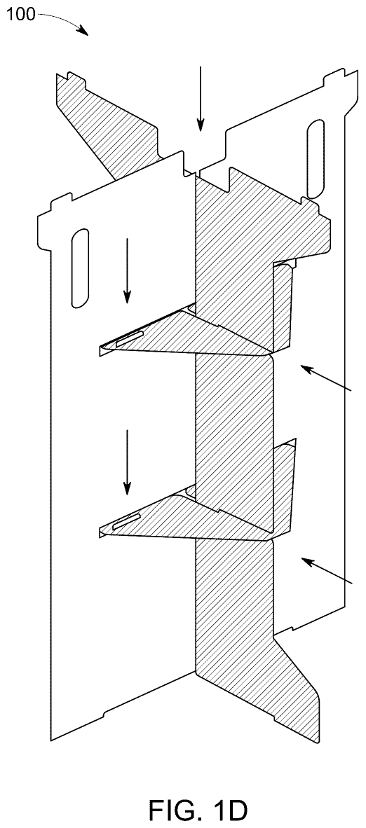

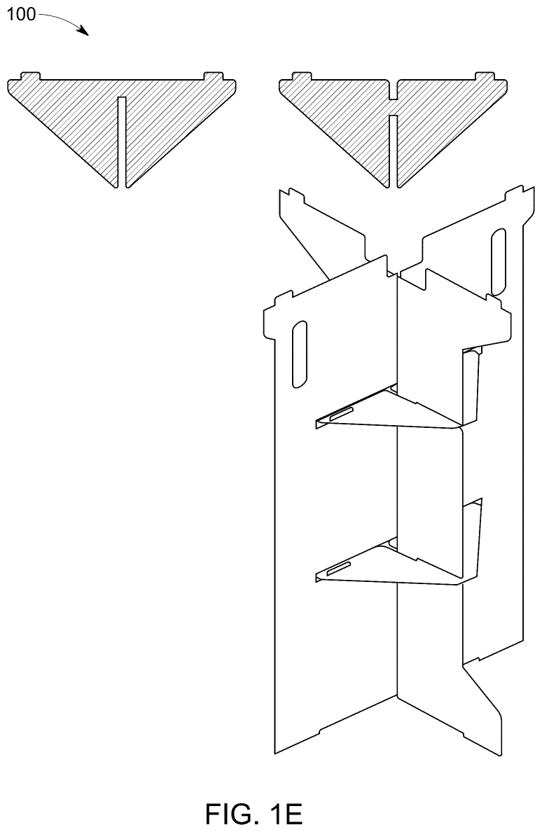

FIG. 1A shows a plan view of a plurality of parts and pieces which can be assembled together to form a podium 100, in accordance with an illustrative embodiment. As shown from left to right, in this embodiment, there is a first vertical support 102, two shelf pieces 104, a second vertical support 106, first and second top support pieces 108, 110, and a top piece 112, which in this embodiment is generally square shaped. In this example, the first vertical support 102 has a wide base 102a, a narrow midsection 102b, and a wide top 102c. The wide base 102a includes an extending foot portion and an open slot 102d for a perpendicular interconnection with a T-shaped slot 106a in the second vertical support 106. The first vertical support 102 further includes lateral slots 102e, 102f for receiving the two shelf pieces104. The wide top 102c of the first vertical support 102 includes extending tabs 102g, 102h which receive the top 112, and a recessed portion 102i for receiving the first and second top supports 108, 110, which are interlocked together in a cross. The wide top 102a of the first vertical support 102 further includes an open slot 102j on its underside, for a second interlocking position 106b within the second vertical support 106. The second vertical support 106 includes slots 106a, 106c arranged to receive the first vertical support 102 perpendicularly, with the shelves 104 in position.

FIGS. 1B-1E show isometric views of the parts and pieces being assembled, step-by-step, to form a finished podium 100, as shown in FIG. 1F. In FIG. 1B, the two shelf pieces 104 are shown being inserted into corresponding slots formed in the first vertical support. FIG. 1C shows the assembly of FIG. 1B being inserted laterally into slots 102e, 102f formed in the second vertical support. FIG. 1D shows how the assembly of FIG. 1B is secured by vertically lowering the assembly 102 to lock into corresponding locking tabs formed in the second vertical support 106. FIG. 1E shows the first and second top support pieces 108, 110 being lowered vertically into position into the assembly of FIG. 1D, such that the first and second support pieces 108, 110 interlock perpendicularly relative to each other. As shown in FIG. 1F in the fully assembled podium 100, these first and second top support pieces 108, 110, along with the assembly of FIG. 1D, provide a surface on which the top 112 can rest. The top is secured in position by locking tabs (in this example, eight—102g, 102h, 106d, 106e, 108a, 108b, 110a, 110b), being received in slots which are evenly spaced around the top 112.

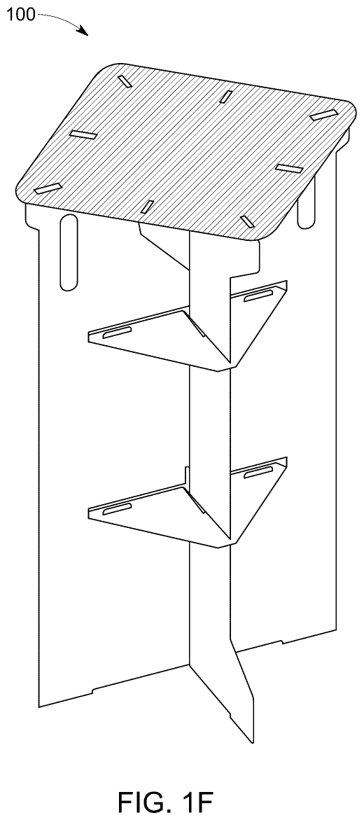

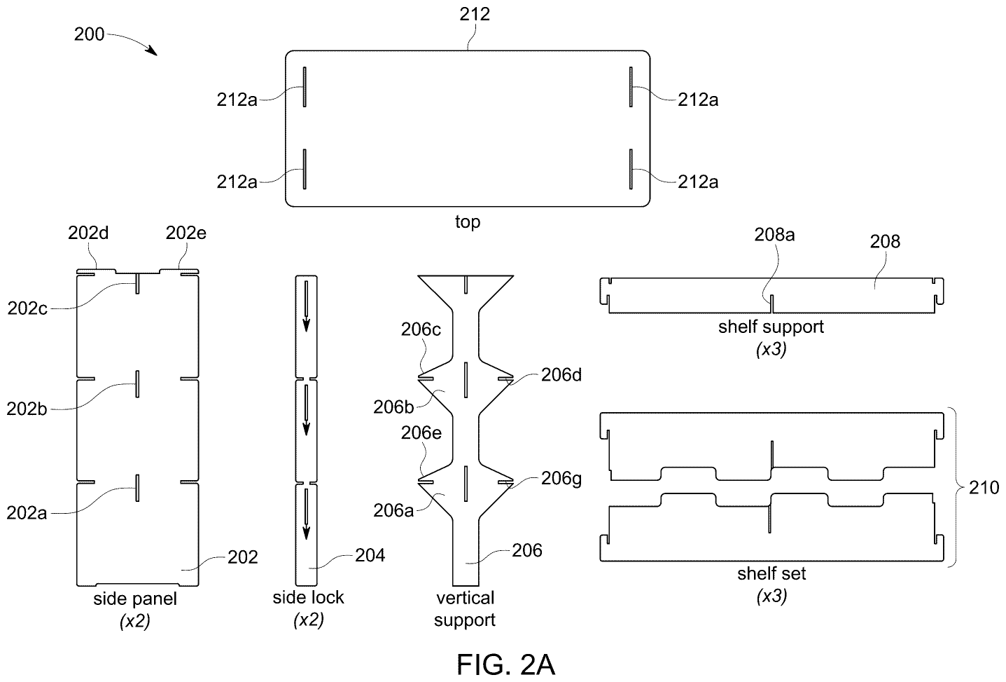

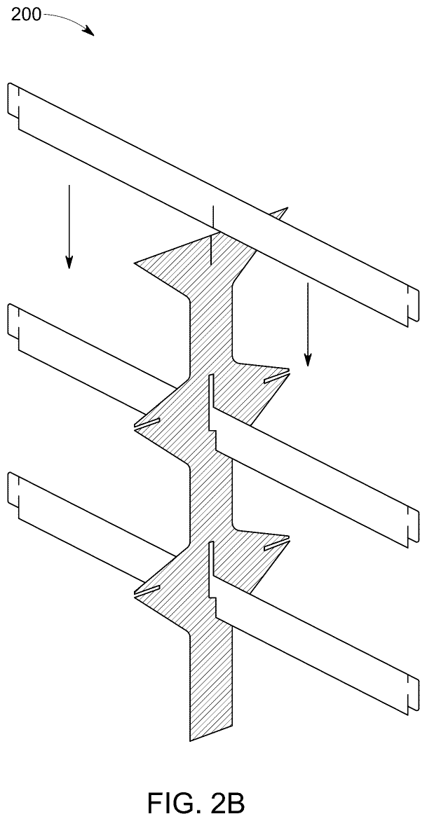

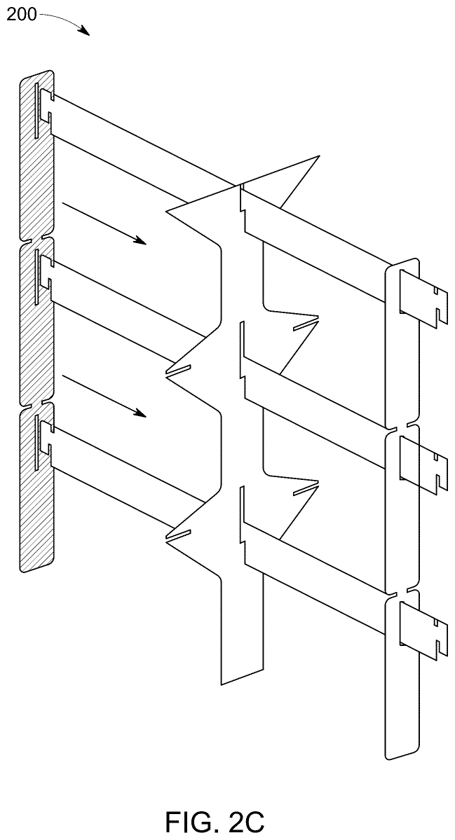

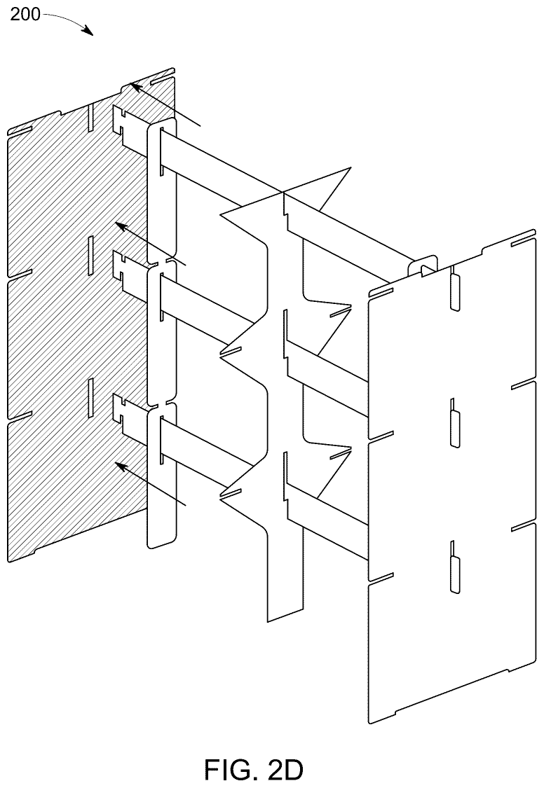

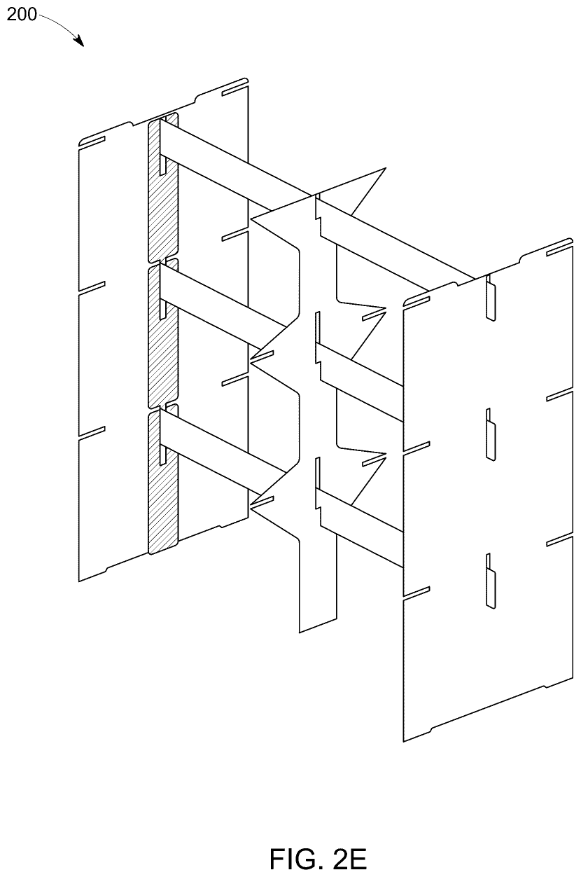

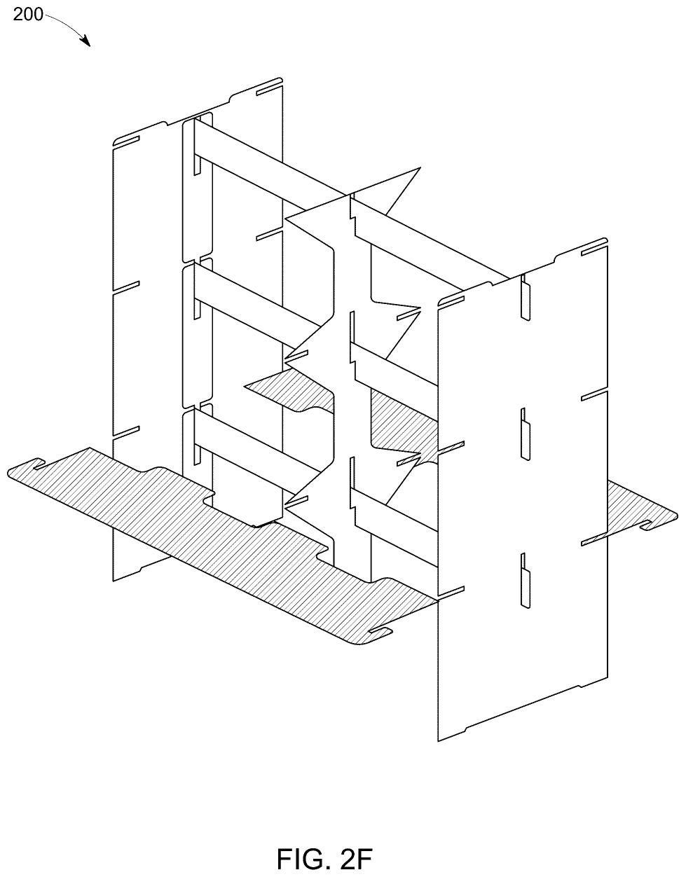

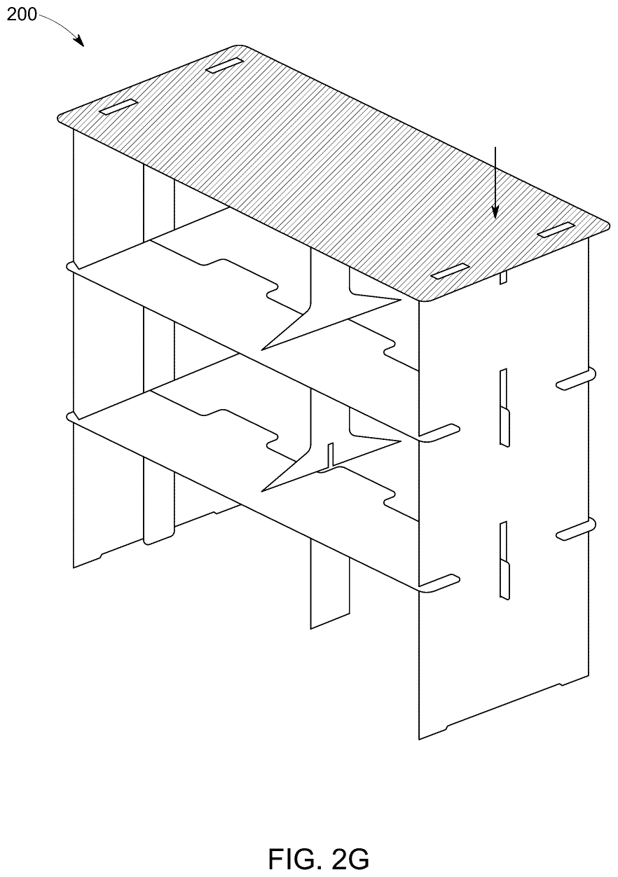

Now referring to FIG. 2A, shown is a plan view of a plurality of parts and pieces which can be assembled together to form a shelf 200, in accordance with an illustrative embodiment. From left to right, shown are first and second side panels 202, first and second slide locks 204, a vertical support 206, a plurality of shelf supports 208, and a plurality of interlocking shelf sets 210. A rectangular top 212 appears as well. In this example, the first and second side panels 202 are generally rectangular and include a plurality of vertically oriented slots 202a, 202b, 202c adapted to receive a plurality of shelf supports 208. The top of the first and second side panels 202 includes extending tabs 202d, 202e located at the top to receive the shelf top 212 which include corresponding slots 212a, 212b. A second vertical support 206 is narrow but includes a number of wider sections 206a, 206b with open slots 206c, 206d, 206e, 206f to receive a pair of interlocking shelf sets 210. The pair of interlocking shelf sets 210 include alternating “square-wave” tabs designed to allow both sections of the shelf set 210 to be supported by a shelf support 208. A pair of side locks 204, which include vertically oriented slots to receive a plurality of shelf supports 208, interlock with both the shelf supports 208 and to the first and second side panels 202.

FIGS. 2B-2G. Show isometric views of the parts and pieces being assembled, step-by-step, to form a finished shelf 200, as shown in FIG. 2H. In FIG. 2B, the plurality of shelf supports 208 are first inserted through corresponding slots formed in the vertical support 206, and vertically lowered into place at a slot 208a formed in the center. In FIG. 2C, first and second side locks 204 are slid onto the plurality of shelf supports. FIG. 2D shows first and second side panels which also engage the plurality of shelf supports 208, and the plurality of shelf supports 208 lock into position in the slots of the side locks 204. FIG. 2E shows how the first and second side locks 204 are slid laterally against the first and second side panels 202, respectively, to lock the first and second side panels 202 in position. FIG. 2F shows the plurality of interlocking shelf sets 210, which are then laterally slid into place from either side, to join at the middle. FIG. 2H shows the rectangular top 212 lowered vertically into position, forming the finished assembly for the shelf 200.

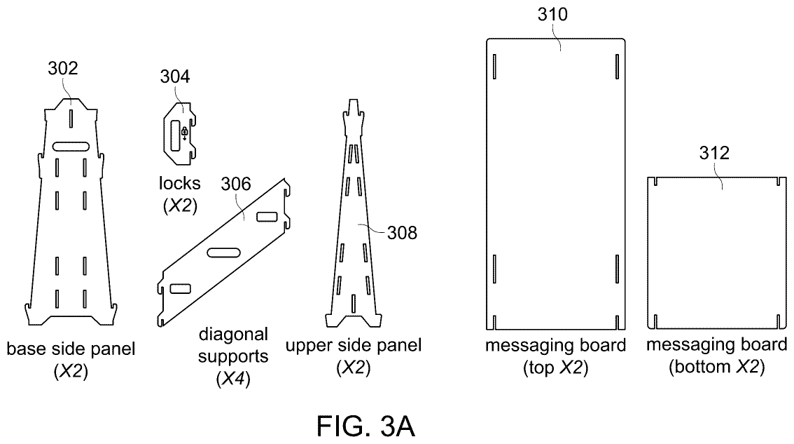

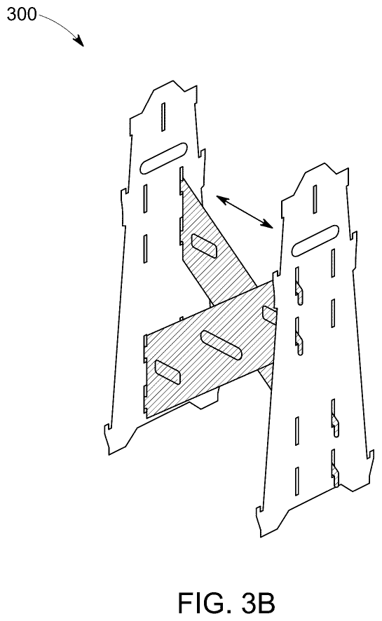

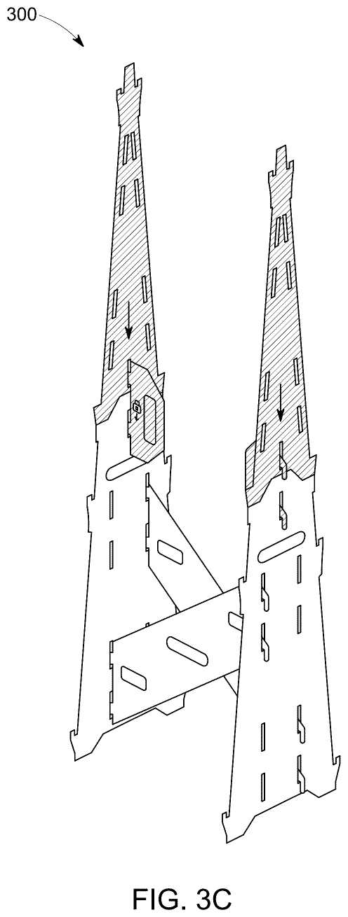

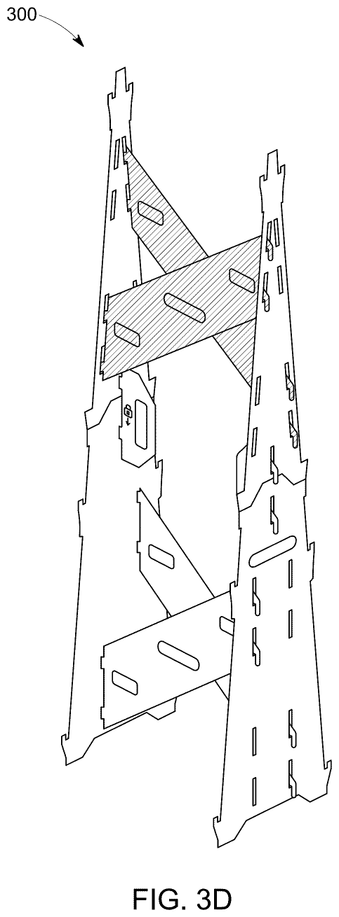

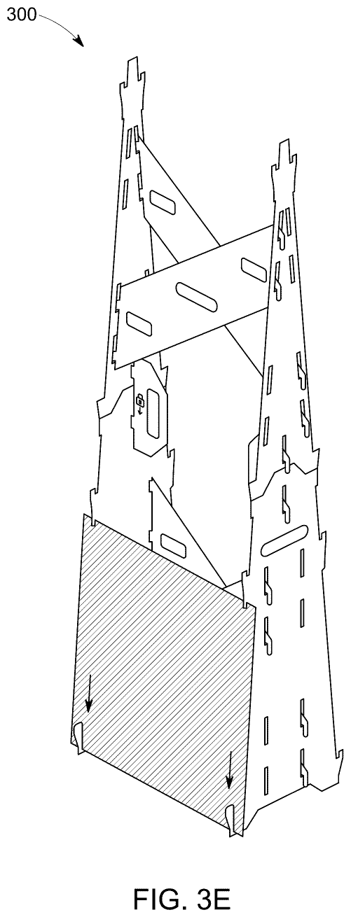

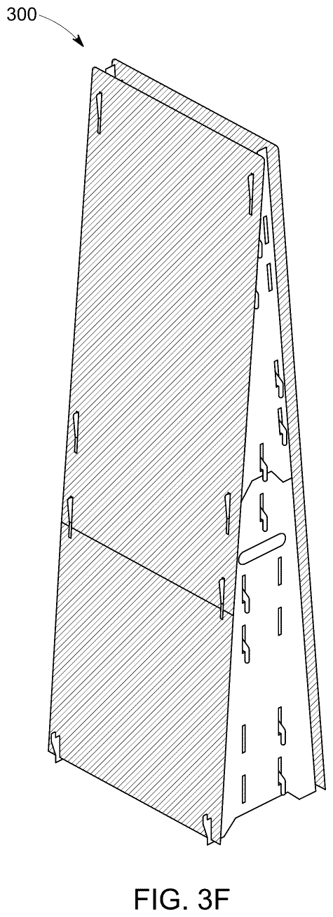

Now referring to FIG. 3A, shown is a plan view of a plurality of parts and pieces which can be assembled together to form a stand 300, in accordance with an illustrative embodiment. From left to right, shown are first and second base side panels 302, first and second locks 304, a plurality of diagonal supports 306, first and second upper side panels 308, first and second tall messaging boards 310, and first and second short messaging boards 312. The first and second base side panels 302 have a wider bottom which narrows towards the top. A plurality of slots are provided to allow the first and second base side panels 302 to interlock with a pair of diagonally oriented, parallelogram shaped supports 306. The pair of upper side panels 308 also includes slots to interlock with a pair of diagonally oriented, parallelogram shaped supports 306. Locks 304 having extending tabs with side notches are used to lock the base side panels 302 to the upper side panels 304, as described below. The messaging boards 310, 312 are suitably shaped and sized and include notches on either side to be interlocked with both sides of the base 302 and/or or upper 308 side panels.

FIGS. 3B-3E show isometric views of the parts and pieces being assembled, step-by-step, to form a finished stand 300, as shown in FIG. 3F. FIG. 3B shows first and second diagonal supports 306 being placed into position between first and second base side panels 302. A pair of diagonal supports 306 are positioned against each other in a cross or X-configuration so as to provide a sturdy cross brace between the first and second base side panels 302. FIG. 3C shows first and upper side panels 308 placed on top of the first and second base side panels 302, and locked into position utilizing the first and second locks 304. FIG. 3E shows another pair of diagonal supports 306 being placed into position between the first and second upper side panels 308 to form a sturdy cross brace between the first and second upper side panels 308. FIG. 3E shows a first short messaging board 312 being lowered and locked into position on the first and second side panels. Similarly, the tall messaging board 310 can also be lowered and locked into position adjacent the short messaging board. Additional messaging boards can be lowered and locked into position on the other side of the first and second base side panels 302, and the first and second upper side panels 308, so as to form the fully assembled stand 300 with messaging boards as shown in FIG. 3F.

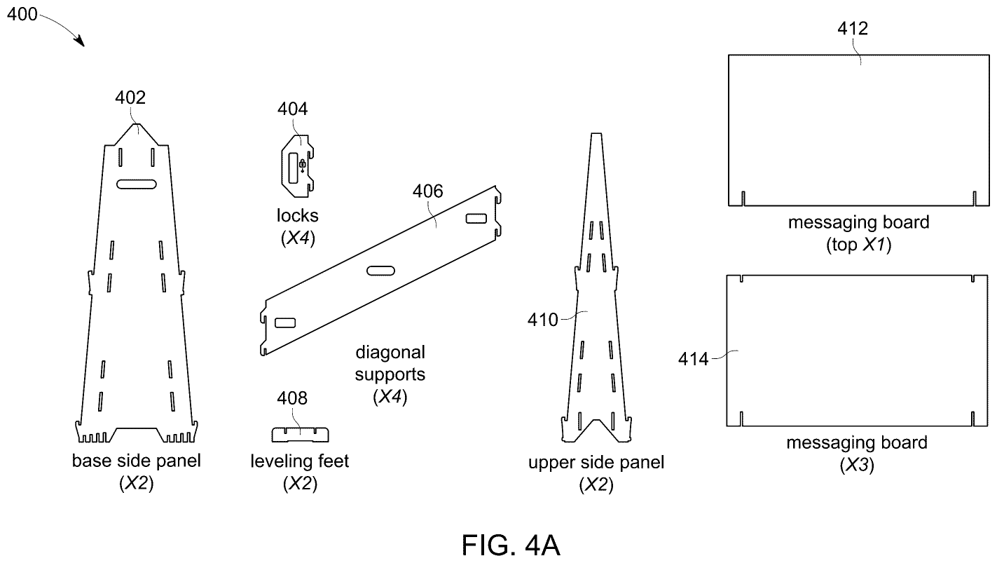

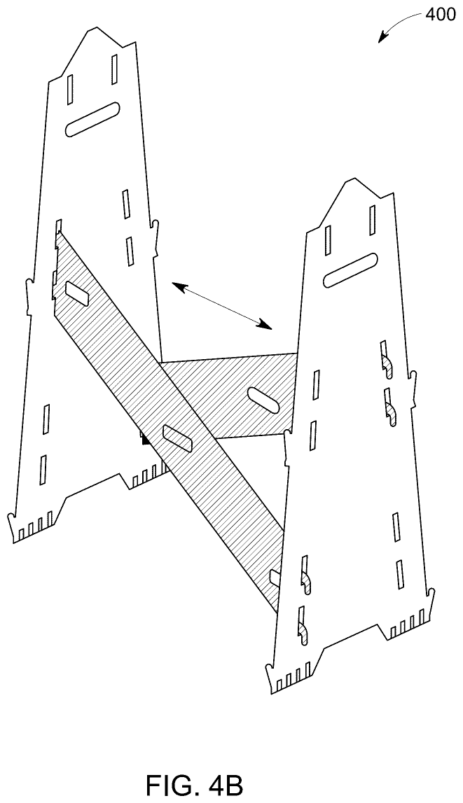

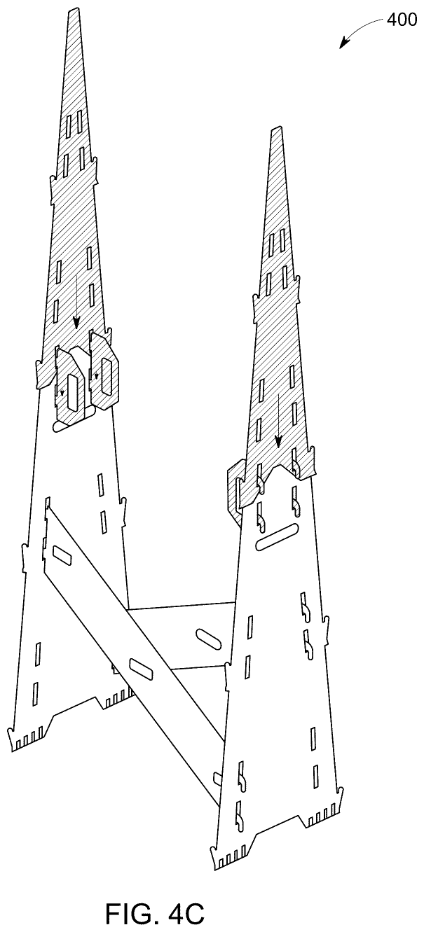

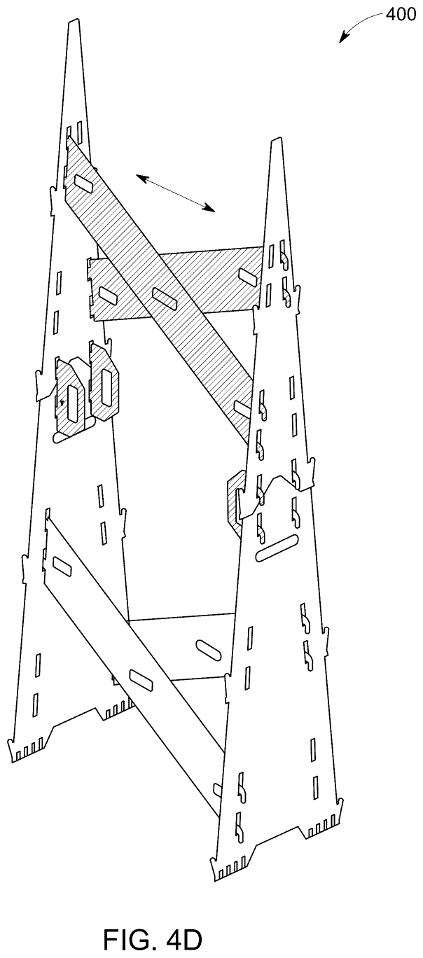

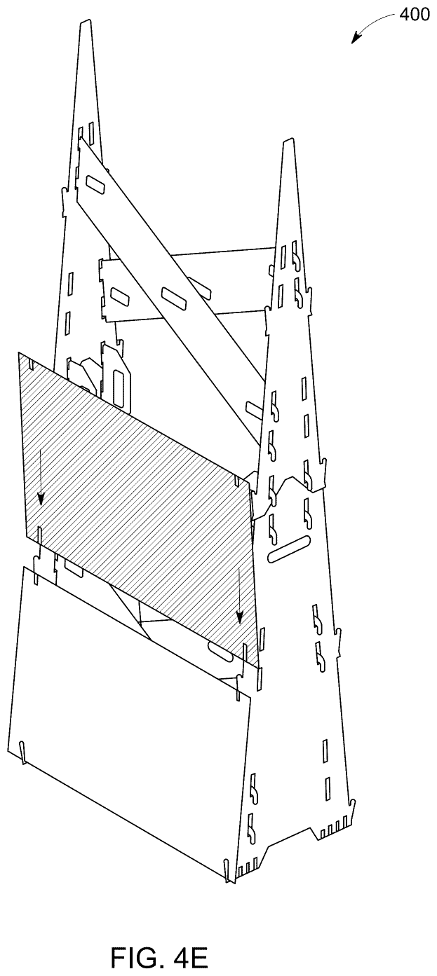

Now referring to FIG. 4A, shown is a plan view of a plurality of parts and pieces which can be assembled together to form a wall 400, in accordance with an illustrative embodiment. From left to right, shown are first and second base side panels 402, a plurality of locks 404, a plurality of diagonal supports 406, a plurality of leveling feet 408, first and second upper side panels 410, and a plurality of messaging boards 414, including a top messaging board 412 which does not have slots at the top. The first and second base side panels 402 have a wider bottom which narrows towards the top. A plurality of slots are provided to allow the first and second base side panels 402 to interlock with a pair of diagonally oriented, parallelogram shaped supports 406. The pair of upper side panels 410 also includes slots to interlock with a pair of diagonally oriented, parallelogram shaped supports 406. A plurality of locks 404 having extending tabs with side notches are used to lock the base side panels 402 to the upper side panels 410, as described below. The messaging boards 412, 414 are suitably shaped and sized and include notches on either side to be interlocked with both sides of the base 402 and/or or upper 410 side panels. Levelling feet 408 are provided to level the corners of the base side panels 402, as may be required.

FIGS. 4B-4E show isometric views of the parts and pieces being assembled, step-by-step, to form a finished wall 400, as shown in FIG. 4F. As shown in FIG. 4B, a pair of diagonal supports 406 can be positioned in a cross or X-configuration to provide a sturdy cross brace for the first and second base side panels 402. FIG. 4C shows how the first and second upper side panels 410 can be placed above the first and second base side panels 402, and locked into position using a plurality of locks 404 slid into corresponding adjacent slots. A second pair of diagonal supports 406 in a cross or X-configuration to provide a sturdy cross brace for the first and second upper side panels 410. Once the assembly of FIG. 4D has been completed, a plurality of messaging boards 412, 414 can be placed onto the assembly to form the finished wall 400 of FIG. 4F. In this example, the top messaging boards 412 do not require slots on their top ends, to provide a more finished appearance.

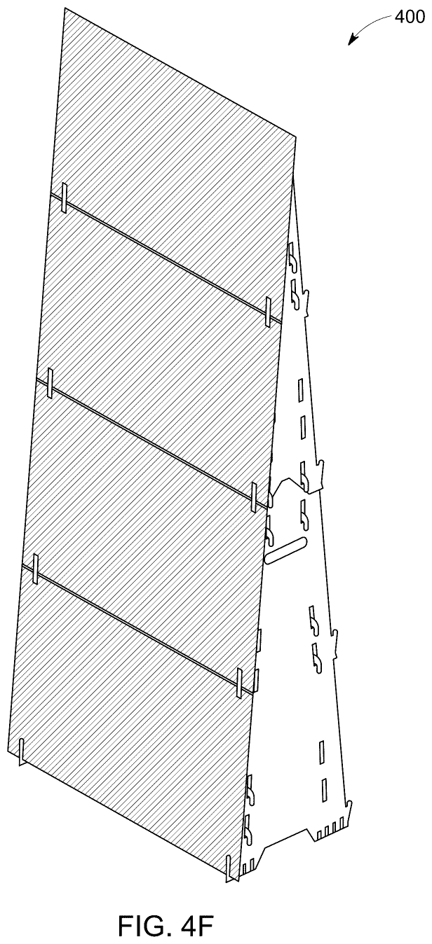

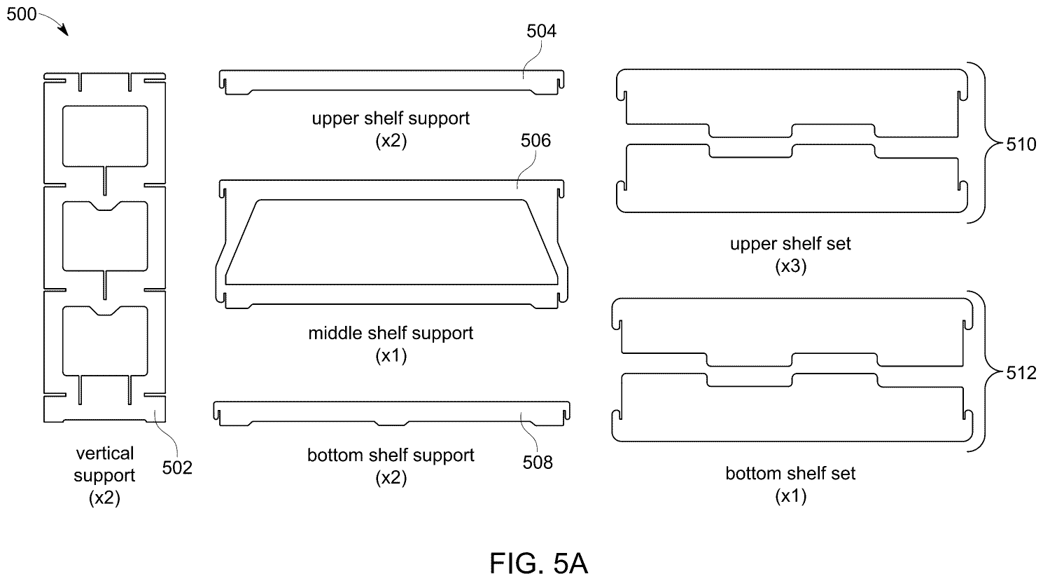

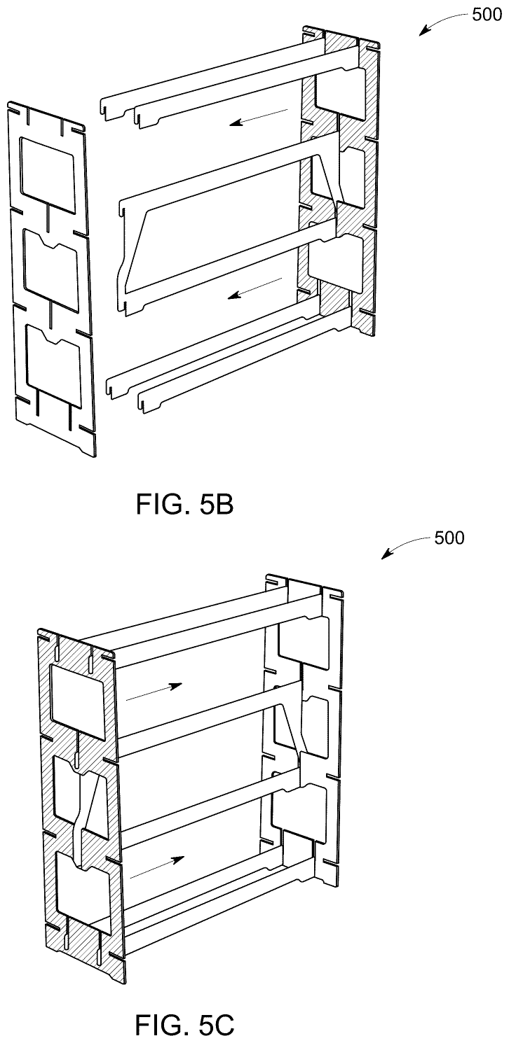

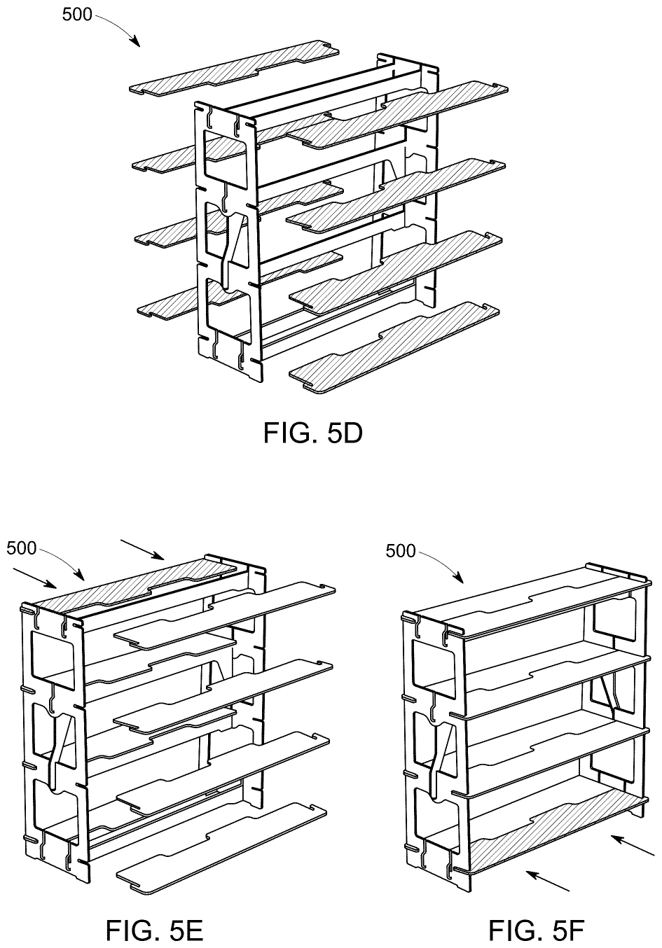

Now referring to FIG. 5A, shown is a plan view of a plurality of parts and pieces which can be assembled together to form another shelf 500, in accordance with an illustrative embodiment. From left to right, shown are a pair of vertical supports 502, a pair of upper shelf supports 504, a middle shelf support 506, and a pair of bottom shelf supports 508, a plurality of upper shelf sets 510 (three sets in this example), and a bottom shelf set 512. The vertical supports 502 include both vertical and horizontal slots. The plurality of upper shelf sets 510 and the bottom shelf set 512 include a “square-wave” pattern of alternating tabs which allow the upper shelf sets 510 and the bottom shelf set 512 to fit together along their inside edges, and to be supported by the horizontal shelf supports 504, 506, 508.

As shown in FIGS. 5B and 5C, the vertical slots of the vertical supports 502 are adapted to receive corresponding extending tabs with hooks provided on each end of the pair of upper shelf supports 504, the middle shelf support 506, and the pair of bottom shelf supports 508.

As shown in FIGS. 5D-5F, the horizontal slots of the vertical supports 502 are adapted to receive corresponding extending tabs with hooks provided on each end of the plurality of upper shelf sets 510, and the bottom shelf set 512 which are adapted to be inserted from either side of the pair of vertical supports 502. The upper shelf sets 510 and the bottom shelf set 512 join together along their inside edge, and are supported by the pair of upper shelf supports 504, the middle shelf support 506 (both upper and lower horizontal sections of the middle shelf support), and the pair of bottom shelf supports 508.

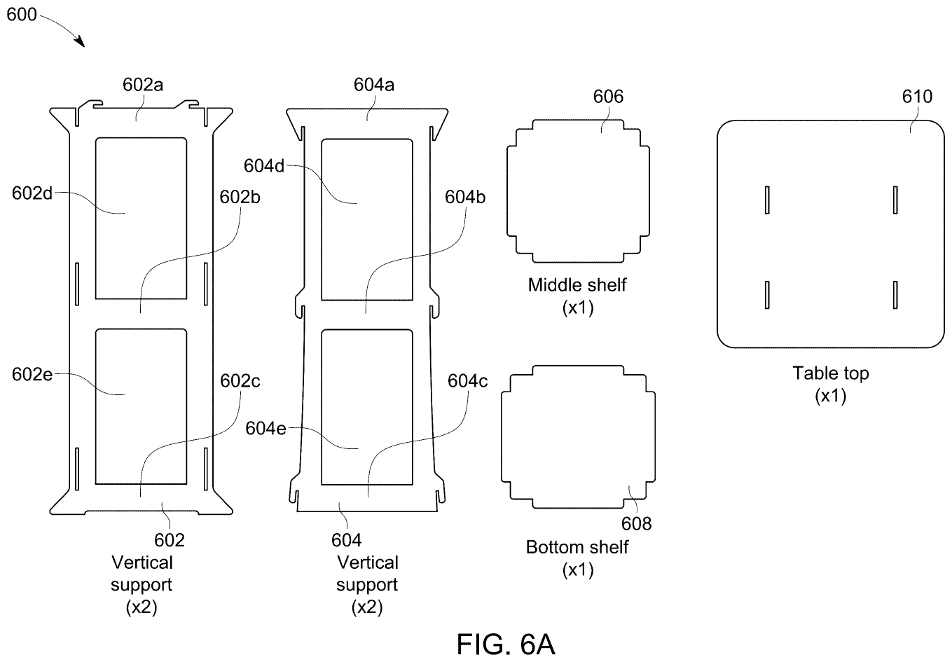

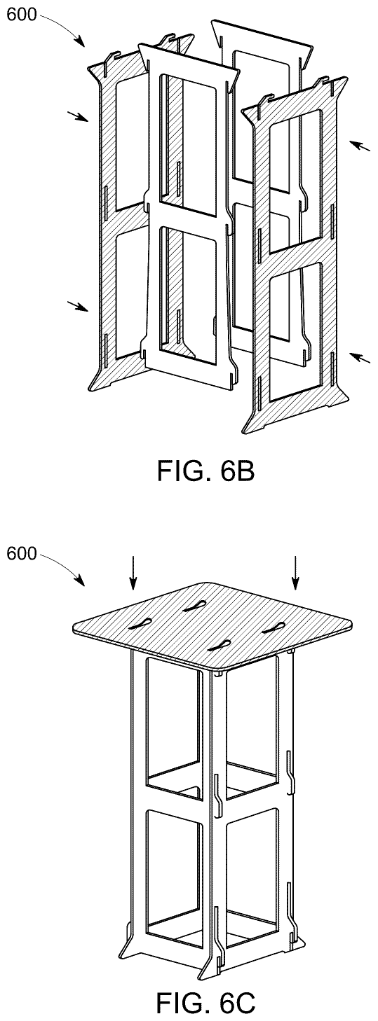

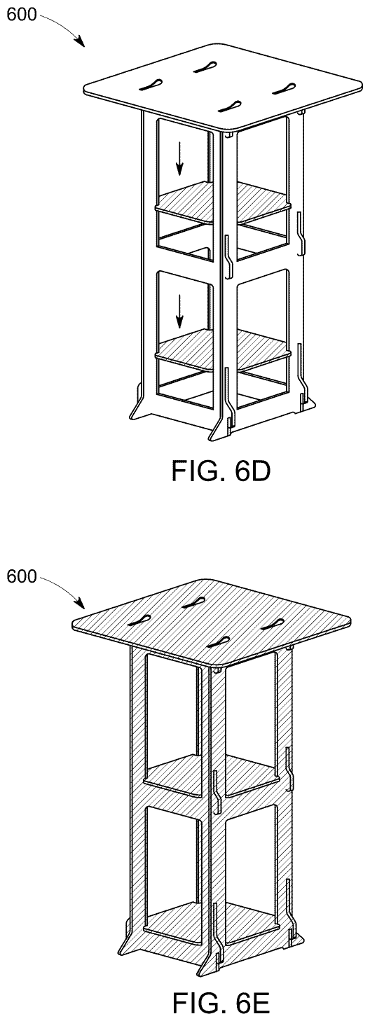

Now referring to FIG. 6A, shown is a plan view of a plurality of parts and pieces which can be assembled together to form a table 600, in accordance with an illustrative embodiment. From left to right, shown are first and second pairs of vertical supports 602, 604, a middle shelf 606, a bottom shelf 608, and a tabletop 610. Both first and second pairs of vertical supports 602, 604 include horizontal braces across the top, middle, and bottom (602a, 602b, 602c, and 604a, 604b, 604c), such that each of the first and second pairs of vertical supports 602, 604 include upper and lower rectangular apertures (602d, 602e and 604d, 604e). The first pair of vertical supports 602 include vertical slots adapted to receive corresponding tabs extending from the sides of the second pair of vertical supports 604. The extending tabs of the second pair of vertical supports 604 include an interlocking hook feature which, in use, locks the tabs within the slots of the first pair of vertical supports 602, as illustrated in FIG. 6B.

As shown in FIG. 6C, the tabletop 610 is placed on top of the vertical supports 602, 604. In this illustrative example, the tabletop 610 includes four slots, each of which align with corresponding extending tabs which extend from the top of, in this case, the first pair of vertical supports 602. The extending tabs may include an interlocking hook feature which hook the tabletop 610 in position.

Now referring to FIG. 6D, the middle shelf 606 and the bottom shelf 608, each of which are shaped to be positioned inside the first and second pairs of vertical supports 602, 604, such that the middle shelf 606 is supported by the middle horizontal feature 602b, 604b, and the bottom shelf is support by the bottom horizontal feature 602c, 604c.

In an embodiment, each of the parts or pieces can be labelled with a corresponding assembly step number, so that each part or piece can be easily identified for assembly.

In another embodiment, each of the parts or pieces can be color coded, to correspond to an assembly step, so that each part or piece can be easily identified for assembly by color code.

In all of the above illustrative examples with assembly instructions, it will be appreciated that disassembly of the fully assembled items can generally follow the assembly guidelines in reverse. Advantageously, assembly and disassembly for any of these items is accomplished without the use of any tools, and a sturdy, fully functional podium can be provided.

As for the materials used to cut or form the parts and pieces, any number of different types of materials may be used, but one illustrative example is cardboard stock, having a tear strength, and a sufficient vertical load or edge crush strength.

As another example, the material used to cut or form the parts and pieces may be a honeycomb board of a sufficient thickness, such as a Falconboard® offered by Packaging Corporation of America of Illinois. Through experimentation, it has been found that a ¼—inch thickness Falconboard® is suitable for forming all of that parts and pieces described by way of example above. However, it will be appreciated that even thicker boards may be used, especially for structural pieces for larger items that may need additional vertical load capacity or tearing or bending strength.

As another example, plastics may be used to form some or all of the parts, in particular the vertical supports and locking pieces, in order to provide additional vertical load strength for heavier loads. Furthermore, if signage is to be used at an outdoor event, plastics would be waterproof, and rain would not be a concern, provided that the signage or messaging boards are also waterproof or water resistant.

In other embodiments, in order to minimize weight, the messaging boards can be of a much lighter and thinner material if desired, as they need not be loadbearing.

As another example, a veneer plywood may be used to cut or form some or all of the parts, but as plywood is heavier, this is recommended only where portability is less important than strength and stability.

Preferably, the materials used are 100% recyclable, such that when they reach end of life, they can be recycled for reuse, rather than going to a landfill. Regardless of the type of material used, it will be appreciated that the parts and pieces are all made from flat sheets or panels of light weight material, and can therefore be packed or repacked as an assembly kit into a slim packing case for transport. If the materials are chosen with weight in mind, then the parts and pieces can also be very light weight for easy transport.

Thus, in an aspect, there is provided a portable event display system, comprising: a plurality of parts and pieces formed from a generally flat sheet or panel, wherein, each of the parts and pieces includes at least one tab or slot configured to interlock with a corresponding slot or tab included in another one of the parts or pieces; and assembly instructions for assembling the parts and pieces, step-by-step; whereby, in use, the plurality of parts and pieces can be manually assembled into a display booth item by following assembly instructions, without the need for any tools or fasteners.

In an embodiment, one or more of the plurality of parts and pieces are cut from a honeycomb board, or lightweight plywood.

In another embodiment, one or more of the plurality of parts and pieces include one or more slots having an extending tab formed on one side for locking one or more parts and pieces with each other.

In another embodiment, one or more of the plurality of parts and pieces include one or more tabs with side slots for slidably locking one or more parts and pieces with each other.

In another embodiment, the one or more of the plurality of parts and pieces include one or more hooks to lock the one or more tabs in position without any fasteners.

In another embodiment, the display booth item is a podium, a shelf, a display, a wall, or a table.

In another embodiment, the assembly instructions for assembling the display booth item comprises identification of the pieces to be assembled with directional arrows assembly.

In another embodiment, the assembly instructions further comprise isometric views of the pieces of the display booth item as they are assembled.

In another embodiment, the assembly instructions further comprise an isometric view of the display booth item fully assembled.

In another embodiment, the display booth item can be disassembled, step-by-step, by following the assembly instructions in reverse.

In another embodiment, there is provided a portable event display method, comprising: providing a plurality of parts and pieces formed from a generally flat sheet or panel, wherein, each of the parts and pieces includes at least one tab or slot configured to interlock with a corresponding slot or tab included in another one of the parts or pieces; and providing assembly instructions for assembling the parts and pieces, step-by-step; whereby, in use, the plurality of parts and pieces are manually assembled into a display booth item by following assembly instructions, without the need for any tools or fasteners.

In an embodiment, the one or more of the plurality of parts and pieces are cut from a honeycomb board, or lightweight plywood.

In another embodiment, the one or more of the plurality of parts and pieces include one or more slots having an extending tab formed on one side for locking one or more parts and pieces with each other.

In another embodiment, the one or more of the plurality of parts and pieces include one or more tabs with side slots for slidably locking one or more parts and pieces with each other.

In another embodiment, the one or more of the plurality of parts and pieces include one or more hooks to lock the one or more tabs in position without any fasteners.

In another embodiment, the display booth item is a podium, a shelf, a display, a wall, or a table.

In another embodiment, the assembly instructions for assembling the display booth item comprises identification of the pieces to be assembled with directional arrows assembly.

In another embodiment, the assembly instructions further comprise isometric views of the pieces of the display booth item as they are assembled.

In another embodiment, the assembly instructions further comprise an isometric view of the display booth item fully assembled.

In another embodiment, the display booth item can be disassembled, step-by-step, by following the assembly instructions in reverse.

While various illustrative embodiments have been shown and described, it will be appreciated that the scope of the invention will be determined by the following claims.

1. A portable event display system, comprising:
a plurality of parts and pieces formed from a generally flat sheet or panel, wherein, each of the parts and pieces includes at least one tab or slot configured to interlock with a corresponding slot or tab included in another one of the parts or pieces; and
assembly instructions for assembling the parts and pieces, step-by-step;
whereby, in use, the plurality of parts and pieces can be manually assembled into a display booth item by following assembly instructions, without the need for any tools or fasteners.

2. The portable event display system of claim 1, wherein, one or more of the plurality of parts and pieces are cut from a honeycomb board, or lightweight plywood.

3. The portable event display system of claim 1, wherein, one or more of the plurality of parts and pieces include one or more slots having an extending tab formed on one side for locking one or more parts and pieces with each other.

4. The portable event display system of claim 1, wherein, one or more of the plurality of parts and pieces include one or more tabs with side slots for slidably locking one or more parts and pieces with each other.

5. The portable display system of claim 4, wherein the one or more of the plurality of parts and pieces include one or more hooks to lock the one or more tabs in position without any fasteners.

6. The portable event display system of claim 1, wherein the display booth item is a podium, a shelf, a display, a wall, or a table.

7. The portable display system of claim 1, wherein the assembly instructions for assembling the display booth item comprises identification of the pieces to be assembled with directional arrows assembly.

8. The portable display system of claim 7, wherein the assembly instructions further comprise isometric views of the pieces of the display booth item as they are assembled.

9. The portable display system of claim 8, wherein the assembly instructions further comprise an isometric view of the display booth item fully assembled.

10. The portable display system of claim 9, wherein the display booth item can be disassembled, step-by-step, by following the assembly instructions in reverse.

11. A portable event display method, comprising:
providing a plurality of parts and pieces formed from a generally flat sheet or panel, wherein, each of the parts and pieces includes at least one tab or slot configured to interlock with a corresponding slot or tab included in another one of the parts or pieces; and
providing assembly instructions for assembling the parts and pieces, step-by-step; whereby, in use, the plurality of parts and pieces can be manually assembled into a display booth item by following assembly instructions, without the need for any tools or fasteners.

12. The portable event display method of claim 11, wherein, one or more of the plurality of parts and pieces are cut from a honeycomb board, or lightweight plywood.

13. The portable event display method of claim 11, wherein, one or more of the plurality of parts and pieces include one or more slots having an extending tab formed on one side for locking one or more parts and pieces with each other.

14. The portable event display method of claim 1, wherein, one or more of the plurality of parts and pieces include one or more tabs with side slots for slidably locking one or more parts and pieces with each other.

15. The portable display method of claim 4, wherein the one or more of the plurality of parts and pieces include one or more hooks to lock the one or more tabs in position without any fasteners.

16. The portable event display method of claim 1, wherein the display booth item is a podium, a shelf, a display, a wall, or a table.

17. The portable display method of claim 1, wherein the assembly instructions for assembling the display booth item comprises identification of the pieces to be assembled with directional arrows assembly.

18. The portable display method of claim 7, wherein the assembly instructions further comprise isometric views of the pieces of the display booth item as they are assembled.

19. The portable display method of claim 8, wherein the assembly instructions further comprise an isometric view of the display booth item fully assembled.

20. The portable display method of claim 9, wherein the display booth item can be disassembled, step-by-step, by following the assembly instructions in reverse.
